(19) United States
(12) Patent Application Publication
(10) Pub. No.: US 2012/0126933 A1
(43) Pub. Date: May 24, 2012

(54) High power water-cooling resistor of converter valve for high voltage direct current transmission

(76) Inventors: Yufeng Qiu, Beijing (CN); Guang fu Tang, Beijing (CN); Juan Zhang, Beijing (CN)

(21) Appl. No.: 13/255,499

(22) PCT Filed: Jun. 16, 2011
(86) PCT No.: PCT/CN2011/001005

§ 371 Date: Sep. 8, 2011

(30) Foreign Application Priority Data
Jun. 30, 2010 (CN) 201010213869.6

(51) Int. Cl. H01C 1/08

(52) U.S. Cl. 338/53

(57) ABSTRACT

This present invention provides a high power water-cooling resistor used for high voltage direct current converter valve, which adopts water-cooling directly. It is characterized by that there are four resistance films, the resistance layer with required resistance, wherein the power of each resistance film can be up to 1500 w at least to form high power resistor. The water flows through one side of resistance film-substrate to take away the heat produced by resistor. The resistor adopts insulated cooling. The thermal resistance between resistor and water is extremely low, and the heat transfer area is also large, the temperature of the resistor declines greatly at the same power. It makes the high power water-cooling resistor have high power to volume ratio; its power can be up to 6 kW under adequate water flow condition. It is suitable for high power condition. The inside space of resistor body is large, so there are some advantages when water cut off is test. The case of the resistor is made of white high strength pps engineering plastic, and it can bear 2 Mpa water pressure, which is better than PVDF material. The inlet and outlet are all the bottom of the resistor, and the wire terminals are the top.

### FIELD OF THE INVENTION

The present invention relates to device of the power system field, and particularly relates to a high power water-cooling resistor of converter valve for high voltage direct current transmission.

### BACKGROUND OF THE INVENTION

Science middle of the 1980s, all of the converter valve adopted water or water/ethylene glycol mixture to cool the valve. Water cooling resistor is an important cooling component, and its performance has great influence on the normal operation of the valve. The direct current converter usually adopts indirect water-cooling, and the water cooling devices and the resistor are independent. This cooling system has huge volume, bad cooling performance. Under the high frequency voltage, the water-cooling resistor will has high impedance. During operation, the valve may be subjected to lighting impulse, steep wave impulse voltage, and produce very high frequency and damage the device.

China patent 200720311343.5 disclosed a simple modular design and fixed dimensions water cooling damping resistor used for converter valve. It is suitable for ultra-high voltage direct current transmission particularly. This resistor includes resistor and insulated enclosure, and it is characterized that: said the insulated enclosure includes cavity and cover. There are some helical water channels inside the cavity, and the outlet and inlet connect with the lower water pipe and the upper water pipe on one side of the cavity, respectively. Said the resistor is a resistance zone, which is located between the helical channels, and the ends connect with lower and upper terminal lugs on another side of the cavity; said the cover connect with the cavity and sealed the helical channels and resistance zone.

China patent 01246810.X disclosed a high power water cooling wire-wound resistor. At present, the high-power wire-wound resistor often links the electric elements by the pressure switch. There are some disadvantages: bad high current impact resistance performance, unsafe and unreliable, huge volume, heavy weight and so on. The resistor provided by the patent overcomes these disadvantages. In this system, there are water channels inside and outside the ceramic tube. There are outlets and inlets on the covers of the ceramic tube. There are resistors outside the tube, and the ends of the resistors are fixed on the covers and formed the resistor core. There are jackets outside the resistor cores formed water flow layer. Two or more cores are fixed parallels between the lower platen with inlets and the upper platen with outlets. The system is constituted by threads and upper and lower electrodes linked by the conduction band.

The present invention high power water-cooling resistor has some advantages compared with described water cooling wire-wound resistors.

Longer life and more reliable—wire-wound resistor is made up of the very fine alloy wire whose length is 6˜10 m usually. During the preparation and wound, the alloy wire may produce some faults and damages. Because the wire-wound resistor directly marinated in the cooling water, the alloy wire will be corroded and release free metal ions. After long period operation, it will cause open resistance and affect water quality. The glass-gazed film resistor adopts film structure. The surface of the matrix covered a glass-gazed conductive layer, which is calcined at 850° C. Even if there are some faults, the resistor also can be used as normal. Therefore, the wire-wound water-cooling resistor is not suitable for high reliable and long life requirements.

Good high voltage pulse performance—the existing technology wire-wound resistor adopts direct water cooling. This resistor can work normally only under the low voltage and good water quality condition, but under the high voltage pulse, there is the turns breakdown risk especially when the water quality decline.

Small inductance—the glass-gazed film resistor adopts surface overall conductive and multi-layer parallel structure. The inductance is extremely low within 100 nH.

High power-volume ratio—to ensure its reliability, wire-wound resistor adopts larger cross sectional area alloy, and then increase the length of the resistor belt because of the alloy belt specific resistance limit. However, the glass-gazed film resistor has more variety of designs without the specific resistance limit and the power to volume ratio is higher than the wire-wound resistor.

Moreover, there is open circuit, affecting water quality and other issues during the operation of the high power wire-wound resistor of the existing technology.

The present invention directly water cooling damping resistor adopted pps material which improved the mechanic strength, heat resistance performance and easy to inject. The power resistor will produce a large volume of high-temperature water vapor when water supply is cut off or the resistor overloaded. Adopting the pps material, the resistor is not easy to deform and damage because of heat. The reliability is greatly improved than PVDF material.

### SUMMARY OF THE INVENTION

This present invention provides a high power water-cooling resistor used for direct current converter valve. It adopts water-cooling directly. There are four resistance films, the resistance layer with required resistance, wherein the power of each resistance film must be up to 1500 w at least to form high power resistor. The resistance film-substrate is fixed and packed into the resistor case. It adopts water-cooling directly, the water flows the left and right sides of said resistance film-substrate to take away the heat produced by the resistor. The inlet and outlet of the high power water-cooling resistor are at the end of resistor case. The resistor adopts insulated cooling. The thermal resistance between resistor and water is extremely low, and the heat transfer area is also large, the temperature of the resistor declines greatly at the same power. It makes the high power water-cooling resistor have high power to volume ratio; its power can be up to 6 kW under adequate water flow condition.

Wherein said resistance film-substrate includes resistance layer and resistor substrate, and said resistance layer consists of four glass-gazed resistance layers in series or/and parallel. Water flow passes through the outside of said resistor substrate to take away the heat produced by the resistor timely. Two ends of said resistance film-substrate are both sealed with seal circles.

Wherein, by controlling said inlet and outlet size to adjust flow rate and control the power of the resistor, the case of said resistance film-substrate is made of the white high strength pps engineering plastic 6, it has smooth surface and 2 Mpa water pressure-resistance

Wherein said outlet and inlet of the high power water-cooling resistor are at the bottom of resistor case, and wire terminals are the top of the resistor case.

Wherein said resistance layer adopts series or/and parallel connection to form variety of resistors.

The advantages of this present invention are described as below:

1, The high power water-cooling resistor of the high voltage direct current transmission converter valve adopts insulated cooling. The thermal resistance between resistor and water is extremely low, and the heat transfer area is large. The temperature of the resistor is much lower at the same power. Therefore, it has high power to volume ratio. It is very suitable for high power condition.

2, The body of the water-cooling resistor adopts glass-gazed resistance substrate, the cool water flows at another side of the resistor layer to take away the heat produced by the resistor. The inside space of the resistor body is large, so there are some advantages when the water cut off is test.

3, The case of the water-cooling resistor is made of the white high strength pps engineering plastic. The surface is smooth and beautiful, and it can bear 2 Mpa water pressure, which is better than PVDF material.

### BRIEF DESCRIPTION OF THE DRAWINGS

FIG. 1 is the overall structure schematic diagram of the present invention resistor;

FIG. 2 is the side view schematic diagram of the present invention resistor;

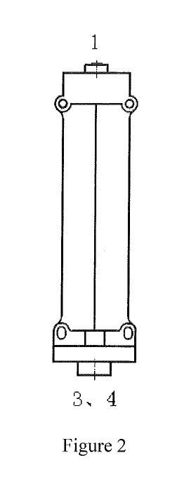

FIG. 3 a cooling principle schematic diagram of the present invention resistor, in these figures:

1-terminal of water cooling resistor; 2-hinge; 3-inlet; 4-outlet; 5-base of resistor; 6-resistor case; 7-water flow; 8-seal circle; 9-resistance layer; 10-resistor substrate;

### DETAILED DESCRIPTION OF EMBODIMENTS

The detail of the embodiments is described as below incorporated with the figures by way of cross-reference.

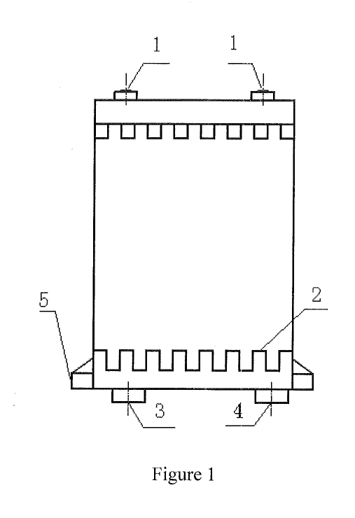

As FIG. 1, 2 shown, the insulated case of a high power water-cooling resistor of converter valve for high voltage direct current transmission includes four parts: the top, the below, the left and the right of the resistor. The four parts are assembled together through hinge 2, and forms a resistor case. The wire terminal 1 is at the top of the resistor body, it is the terminal. The inlet 3 and the outlet 4 are all at the bottom of the resistor body.

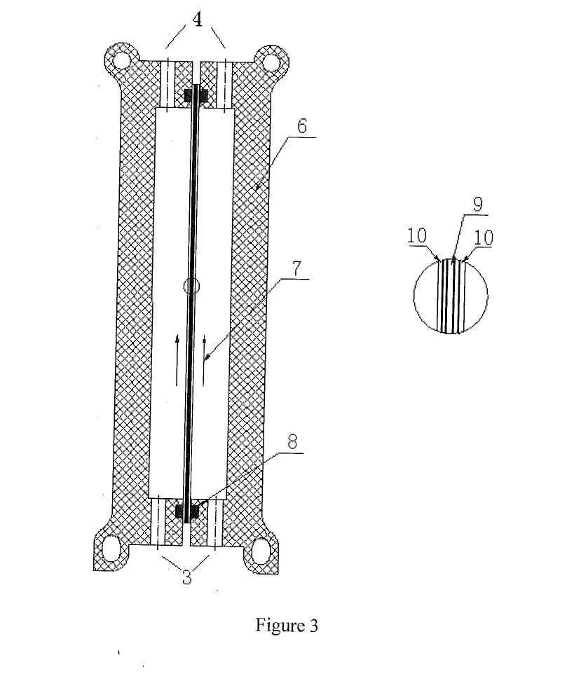

As FIG. 3 shown, the inside of a high power water-cooling resistor of converter valve for high voltage direct current transmission includes resistor substrate 10 and resistance layer 9. The resistance layer 9 consists of four glass-gazed resistance layers in series or/and parallel, cool water 7 flows outside of the resistor substrate 10 to take away the heat produced by the resistor timely. The top and below of resistor are both sealed with seal circles 8.

In the embodiments, the resistance can be adjusted by controlling glass-gazed resistance layers in series or/and parallels. The power of the resistor is controlled by controlling the inlet and outlet size to adjust flow rate. The four parts of the resistor are all molded precise and there is no welded joint. The case of resistor is made of the white high strength pps engineering plastic 6. The surface is smooth and beautiful, and it can bear 2 Mpa water pressure.

To overcome the problems of the existing technology water-cooling resistor like bad heat dissipation and higher inductance, the present invention provided a non-inductance, good heat dissipation water-cooling resistor. The detail of the embodiments is described as below:

A direct water-cooling resistor of direct current converter valve and particularly the resistor adopt direct water-cooling. The present resistor adopts insulated cooling. The thermal resistance between resistor and water is extremely low, and the heat transfer area is large. The temperature of the resistor is much lower at the same power. Therefore, it has high power to volume ratio. Its power can be up to 6 kW under adequate water flow condition. It is very suitable for high power condition.

Wherein said resistor adopts glass-gazed resistance substrate, the cool water flows at another side of the resistor layer to take away the heat produced by the resistor. The inside space of the resistor body is large, so there are some advantages when the water cut off is test.

Wherein the inlet and outlet of said resistor are the bottom of the resistor, the wire terminals are the top and side of the resistor body and the bottom is supported by the insulated brackets.

At last, in this description of the embodiments, we have detail describe the present invention according to a particular example. The detail embodiment is one example of the invention but not the only one, so the person in this field must be understand that all the alternatives and other equal and/or similar examples are all within the range of the invention and they are all consistent with the spirits of this invention, are all protected by our claims.

1. A high power water cooling resistor used for high voltage direct current converter valve is characterized by: it adopts water cooling directly, there are four resistance films, the resistance layer with required resistance, wherein the power of each resistance film must be up to 1500 w at least to form high power resistor, the resistance film-substrate is fixed and packed into the resistor case, it adopts water cooling directly, the water flows the left and right sides of said resistance film-substrate to take away the heat produced by the resistor, the inlet and outlet of the high power water cooling resistor are at the end of resistor case; the resistor adopts insulated cooling, the thermal resistance between resistor and water is extremely low, and the heat transfer area is also large, at the same power the temperature of the resistor declines greatly, it makes the high power water cooling resistor have high power to volume ratio, its power can be up to 6 kW under adequate water flow condition.

2. A water cooling resistor according to claim 1, wherein said resistance film-substrate includes resistance layer 9 and resistor substrate 10, and said resistance layer 9 consists of four glass-gazed resistance layers in series or/and parallel, water flow 7 passes through the outside of said resistor substrate 10 to take away the heat produced by the resistor timely, two ends of said resistance film-substrate are both sealed with seal circles 8.

3. A water cooling resistor according to claim 2, wherein by controlling said inlet and outlet size to adjust flow rate and control the power of the resistor, the case of said resistance film-substrate is made of the white high strength pps engineering plastic 6, it has smooth surface and 2 Mpa water pressure-resistance.

4. A water cooling resistor according to claim 3, wherein said outlet and inlet of the high power water cooling resistor are at the bottom of resistor case, and wire terminals are the top of the resistor case.

5. A water cooling resistor according to claim 4, wherein said resistance layer 9 adopts series or/and parallel connection to form variety of resistors.
